(19) United States
(12) Patent Application Publication
(10) Pub. No.: US 2018/0046722 A1
(43) Pub. Date: Feb. 15, 2018

(54) COMPUTER-IMPLEMENTED METHOD FOR DETERMINING THE INTERSECTION IN SPACE AND TIME BETWEEN AN ENTITY AND AN EVENT

(71) Applicant: Jacques Thibault, Montreal (CA)

(72) Inventor: Jacques Thibault, Montreal (CA)

(21) Appl. No.: 15/659,701

(22) Filed: Jul. 26, 2017

Related U.S. Application Data
(60) Provisional application No. 62/372,358, filed on Aug. 9, 2016.

(51) Int. Cl. G06F 17/30

(52) U.S. Cl. CPC G06F 17/30867; G06F 17/30241; H04L 67/10

(57) ABSTRACT

The computer-implemented method of determining the intersection in space and time between an entity and an event comprises inputting, at an event computer, event data to be stored in an event database. The event data comprises event identification data, finite or infinite event duration data representing an event duration, and event geographical location data representing geographical locations, the event geographical location data being defined over time during the event duration. The method also comprises obtaining, at a server, entity data that comprises entity identification data, finite or infinite entity duration data representing an entity duration, and entity geographical location data representing a geographical location, the entity geographical data being defined over time during the entity duration. The method also comprises obtaining, at the server, the event data and comparing, at the server, the event geographical location data with the entity geographical location data to determine if they match at corresponding times during the entity and event durations. The method finally comprises generating, at the server, intersection output data representing matching the event and entity geographical location data at corresponding times during the entity and event durations.

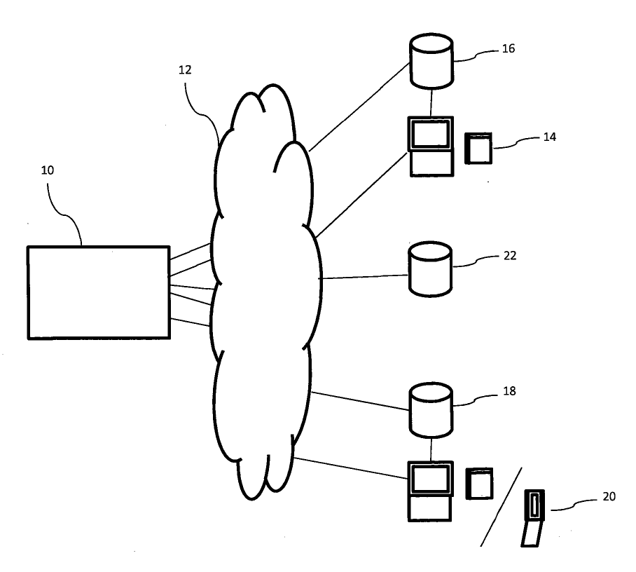

### CROSS-REFERENCE DATA

The present application claims the priority of U.S. provisional patent application No. 62/372,358 filed on Aug. 9, 2016.

### FIELD OF THE INVENTION

The present invention pertains to computer-implemented methods for tracking the position of individuals, or entities, and events, and more particularly to a computer-implemented method of determining the intersection in space and time between an entity and an event or between two events.

### BACKGROUND OF THE INVENTION

Automated means exist to position and track events, for example to determine the intersection of two events with each other, or of an entity with an event, such as whether a person travelling (an entity) will be travelling or has traveled through a geographical area of contagious disease (a second event), whether a tornado (a first event) will intersect the geographical position of a community (a stationary second event), or whether this tornado will intersect a group of cyclists (a mobile entity).

In prior art methods, determining whether there is a risk for a person travelling involved determining, with a database, whether this person's planned and/or actual travel itinerary would bring this person within a specific area determined to be at risk. For example, a traveler (item A in a risk database) might plan to visit a given country (item X in the risk database) and if item A includes within it planned or actual travel locations, location X, then a message would be sent to the traveler to advise this person of the risks associated, in the risk database, with location X. Usually, these locations are simply identified by country name in the risk database, for example the entire country of Brazil might be associated with a certain risk that pertains to that country. There is no timeframe associated to the risk: either it is presently associated with location X, or it is not.

Prior art systems consequently fail to provide useful tools for properly approximating geographical locations: these locations are usually defined as a unique database entry, such as “Cuba”, with data relating to this database entry. It is desirable to allow for other geographical approximations.

Furthermore, prior art systems fail to provide useful tools for allowing the events be assessed over time. Past or future travels of the person might not be taken into consideration when assessing the risk. Failings of the prior art consequently include tracking whether a person travels within a given area not only at the time when the verification is made, but also in the future or, inversely, backtracking the travel of this person in the past. This is useful for example when an event moves, such as a tropical storm, or when its size changes, such as an area of contagious disease; and it is further useful not only to warn travelers of the upcoming danger, but also to verify whether the traveler was in possible contact with the event, such as whether the traveler indeed traveled through a contagious area.

### SUMMARY OF THE INVENTION

The present invention relates to a computer-implemented method of determining the intersection in space and time between an entity and an event, comprising:
inputting, at an event computer, event data to be stored in an event database, said event data comprising:
   event identification data;
   finite or infinite event duration data representing an event duration; and
   event geographical location data representing geographical locations, said event geographical location data being defined over time during said event duration;
obtaining, at a server, entity data comprising:
   entity identification data;
   finite or infinite entity duration data representing an entity duration; and
   entity geographical location data representing a geographical location, said entity geographical data being defined over time during said entity duration;
obtaining, at said server, said event data;
comparing, at said server, said event geographical location data with said entity geographical location data to determine if they match at corresponding times during said entity and event durations; and
generating, at said server, intersection output data representing matching said event and entity geographical location data at corresponding times during said entity and event durations.

In one embodiment, said step of obtaining, at said server, said entity geographical location data during said entity duration, comprises obtaining said geographical location data at said server from a portable computer device equipped with a Global Positioning System that communicates with said server during said entity duration.

In one embodiment, said step of obtaining, at said server, said entity geographical location data during said entity duration, comprises inputting, at an entity computer, said entity data to be stored in an entity database, with said server retrieving said entity geographical location data from said entity database.

In one embodiment, said geographical locations that represent said event geographical location data comprise a number of discrete geographical points of relevance each having geographical coordinates and a local area of effect about each said point of relevance forming a total area of effect from said local areas of effect.

In one embodiment, said event geographical location data evolves over time by one or more of adding and removing geographical points of relevance and modifying the local areas of effect about each said points of relevance.

In one embodiment, said points of relevance are each defined by longitude and latitude coordinates.

In one embodiment, said points of relevance are geographically movable over time.

In one embodiment, said event duration is retroactive with respect to a current time.

In one embodiment, said entity duration is retroactive with respect to a current time.

In one embodiment, said server includes said event computer.

In one embodiment, said server includes both said event computer and said entity computer.

In one embodiment, after the step of generating said intersection output data, the method comprises the additional step of sending, with said server, a warning notification in an electronic message that is representative of said intersection output data to entity coordinates associated to said entity identification data.

In one embodiment, said points of relevance are obtained from a database of geographical locations and each corresponds to one of a city, a state and a country.

In one embodiment, the size of each said local area of effects is proportional to the population associated with its corresponding said point of relevance.

In one embodiment, the size of each said local area of effect is defined through customized data entry.

The present invention also relates to a method of representing first and second events in space and time and calculating the intersection thereof comprising:
for each said event, defining a number of discrete geographical points of relevance each having geographical coordinates;
defining a local area of effect about each said point of relevance;
for each said event, generating a total area of effect from said local areas of effect of said event;
defining or adjusting a duration in time for each said event as delimited by start and stop dates and times;
repeating steps (a) to (d) for said duration of each said event until said stop date and time are reached, to integrate the geographical and time parameters to create a space-time data set for each said event; and
calculating the intersection of said first and second events in space and in time from the data sets of said first and second events.

### BRIEF DESCRIPTION OF THE DRAWINGS

In the single page of annexed drawings:

The FIGURE is a schematic representation of a computer system that can be used to implement the computer-implemented method of determining the intersection in space and time between an entity and an event according to the present invention.

### DETAILED DESCRIPTION OF THE EMBODIMENTS

The present invention is generally aimed at a computer-implemented method of determining the intersection in space and time between an entity and an event. The invention is implemented over a computerized environment including any required computers, servers, databases and other hardware or software, as will readily be understood by a person skilled in the art.

The FIGURE is a schematic view of an example of a conventional general-purpose computerized environment that can be used to implement various aspects of the present invention. In The FIGURE, a server 10 is connected to a network 12. An event computer 14 is linked to both the network 12 and to an event database 16. An entity computer 18 is linked to both the network 12 and to an entity database 20. A geographical location database 22 is also linked to network 12.

Each computer including server 10, event computer 14 and entity computer 20 includes all hardware and software necessary to work in a computerized environment, including a processing unit, a system memory, and a system bus that couples various system components including the system memory to the processing unit. The system memory includes read only memory (ROM) and random access memory (RAM). A basic input/output system (BIOS), containing the basic routines that help to transfer information between elements within the computer, such as during start-up, is stored in the ROM. The computer also includes a hard disk drive for reading from and writing to a hard disk and any other data storage units. The drive and its associated computer-readable media provide nonvolatile storage of computer readable instructions, data structures, program modules and other data for the computer.

A number of program modules can be stored on the hard disk drive or other storage units, ROM or RAM, including an operating system, one or more application programs, other program modules, and program data. A user can enter commands and information into the computer through input devices such as a keyboard and pointing device. Other input devices may include a microphone, joystick, game pad, satellite dish, scanner or the like. These and other input devices are often connected to the processing unit through a serial port interface that is coupled to the system bus, but may be connected by other interfaces, such as a parallel port, game port or a universal serial bus (USB). Further still, these devices may be coupled directly to the system bus via an appropriate interface. A monitor or other type of display device is also connected to the system bus via an interface, such as a video adapter.

The computers can operate in a networked environment through network 12 that may include one or more interconnected networks. This communication occurs by using logical connections among the computers or to one or more other remote computers (not shown in the FIGURE). The remote computers can be an additional server, a router, a network PC, a peer device or other common network node, and typically includes many or all of the elements described above relative to the computers 10, 14, 20. Network 12 can be a local area network (LAN) and/or a wide area network (WAN). Such networking environments are commonplace in offices, enterprise-wide computer networks, intranets and the Internet.

When used in a LAN networking environment, the computers are connected to the local network through a network interface or adapter. When used in a WAN networking environment, the personal computers typically include or are otherwise connected to a modem or other means for establishing a communications over the wide area network, such as the Internet. In a networked environment, program modules relative to the personal computers, or portions thereof, may be stored in a remote memory storage device.

The existence of any of various well-known protocols such as TCP/IP, Ethernet, FTP, HTTP, Bluetooth, and the like is presumed, and the system can be operated in a client-server configuration to permit a user to retrieve web pages from a web-based server. Any of various conventional web browsers can be used to display and manipulate data on web pages. Any of the data entry or retrieval can be made through web pages, or by use of programs or applications locally installed on the computers, or both.

Furthermore, entity computer 20 in particular, but any other computer, can comprise, in full or in part, a portable computer, a hand-held cellular phone, or any other type of known computing devices that are nowadays commonplace. It is particularly contemplated that the entity computer 20 could be a cell phone that a person (entity) carries with him.

According to the present invention, an event positioning and tracking system is installed and operates on server 10 where event intersection data is calculated, saved and communicated. More particularly, the computer-implemented method of the invention aims to determine the intersection in space and time between an entity and an event. The entity can be, for example, a person or a group of persons travelling, such as employees of a private company, public service employee, tourists, or the like. The event can be a weather event such as a storm or a hurricane; an epidemic; a situation of public disorder; or the like. According to the present invention, it is possible notably to automate the determination of the intersection between the entity and the event.

The method of the invention comprises first inputting, at the event computer 14 or directly at server 10, event data to be stored in event database 16. As mentioned above, event computer 14 can be any computer linked to network 12, and could include governmental agencies computers, non-profit organization computers, personal computers, and the like.

The event data to be inputted into event database 16 comprises event identification data, such as an event code or an event name, that allows managing the database entry. The event data further comprises finite or infinite event duration data representing an event duration. This duration allows a start date and time and an end date and time to be determined, with respect to the current date and time. If the duration is infinite, there is no end date and time and the event is then considered continuous until an end date and time are manually inputted into the database.

The event data further comprises event geographical location data representing geographical locations, the event geographical location data being defined over time during the event duration. The event geographical location data representing geographical locations comprises a number of discrete geographical points of relevance each having geographical coordinates and a local area of effect about each point of relevance forming a total area of effect from the local areas of effect.

In one embodiment, the points of relevance are each defined by longitude and latitude coordinates.

In another embodiment, the points of relevance are obtained from the database of geographical locations 22. The points of relevance can then be, for example, a city, a state or a country. Any other human settlement, such as industrial sites or other distinctive settlement, can be used.

The size of each the local area of effects can be proportional to the population associated with its corresponding point of relevance. For instance, if points of relevance are cities, then larger cities would have larger areas of effects in the events database.

In another embodiment, the size of each the local area of effect is defined through customized data entry, for instance at server 10. For example, if the event is an epidemic, the size of each local area of effect could be determined according to the spread if the epidemic as measured on the field. Alternately, the size of the local areas of effect could be determined from other criteria, for instance if industrial sites are used as points of relevance, then the size of their area of effect could be determined according to the relative importance of the industrial site. Generally, a means of determining the importance of geographical locations worldwide is achieved and a database including these geographical locations is part of the present invention.

The geographical location data of the event evolves over time, for events that are not static in space and time. This means that as an event progresses or regresses, geographical points of relevance can be added or removed, and the size of the local areas of effect about each point of relevance can be adjusted accordingly.

Moreover, the geographical points of relevance can be geographically movable over time. Instead of manually adding or removing points of relevance through data entry at server 10 or at event computer 14, a speed of displacement, or a rate of progression or regression of the event can be inputted, whereby the points of relevance will be added or removed automatically, or the size of each local area of effect will be increased or decreased, according to this displacement, rate of progression or rate of regression.

It is noted that the event duration can be retroactively inputted when it is initially created, i.e. either the start date and time, or both the start and end dates and times, can be antecedent to the data entry current date and time.

The invention further comprises obtaining, at server 10, entity geographical location data that can be inputted directly at server 10, or alternately at entity computer 20, which can (and in many embodiments, will) include portable computing devices such as cellular phones. The entity geographical location data comprises entity identification data such as a traveler's name, phone number or code.

The entity geographical location data further includes a finite or infinite entity duration data representing an entity duration, namely start dates and times that allow for example the traveling dates of a traveler to be known. In the case of an infinite entity duration, no end date and time is provided, and the entity duration is continuous until it is ended for example through manual data entry.

The entity geographical location data further includes entity geographical location data representing a geographical location, for instance longitude and latitude coordinates, country name, city name, or the like. The entity geographical data is further defined over time during the entity duration, namely the database entry includes displacements of the entity to different geographical locations.

As with the event duration, the entity duration can be retroactive with respect to a current time, for example for tracking past travels of an individual.

The step of obtaining, at the server, the entity geographical location data during the entity duration, can include obtaining the geographical location data at the server from a portable computer device such as a cellular phone equipped with a Global Positioning System that communicates with the server during the entity duration. This allows continuous real-time geo-positioning of the cellular phone and the entity associated to it.

Alternately, the step of obtaining, at the server, the entity geographical location data during the entity duration, could include simply, at entity computer 20, the entity data to be entered and stored in entity database 18. For example, travelers could be asked to login to accounts that are stored in entity database 18 from any computer as they travel, to allow voluntary tracking of their position.

In use, when the intersection in space and time between an event and an entity is to be determined, the method of the invention comprises first obtaining, at the server, the event data. For example, this is accomplished by simply retrieving the data from the event database 16.

Then, the server compares the event data geographical location data with the entity geographical location data to determine if they match at corresponding times during the entity and event durations. If they match, this means that the entity is travelling at a geographical location, namely within the area of effect centered about a point of relevance, during a time in which the event is occurring at that geographical location. This determination will include identification of the geo-positioning of the entity and determining whether it is located within one of the areas of effects of the different points of relevance of the event geographical location data.

If the entity and event geographical data match at a given time, the server generates intersection output data representing the matching event and entity geographical location data at the corresponding times during the entity and event durations. This intersection output data can be processed as desired, for example it can be consulted by users of server 10, and it can be communicated, with server 10, within a warning notification to entity coordinates, such as an email address, associated to the entity identification data.

The present invention can also be used to determine the intersection in space and time of first and second events, as opposed to that of a first event with an entity. This is similar to the first embodiment, but both events are then defined similarly to the single event of the first embodiment. More particularly, in this alternate embodiment, the method comprises, for each the event, defining a number of discrete geographical points of relevance each having geographical coordinates, and defining a local area of effect about each point of relevance from which a total area of effect is generated. Then, a duration is defined or adjusted for each event as delimited by start and stop dates and times, including the possibility of having finite or infinite durations as mentioned above. The event geographical points of relevance and their local areas of effect can be adjusted for the duration of each event until the stop date and time are reached, to integrate the geographical and time parameters to create a space-time data set for each event. From this, it is possible for the server to calculate the intersection of the first and second events in space and in time from the data sets of the first and second events.

The invention's applications are numerous. For example, it could used to determine that a traveler has entered a region touched by an epidemic in his past travels, helping to trace individuals who have been in the region where the epidemic existed before it became known that it existed, to hopefully help prevent further transmission of the disease or to contact the individuals to propose medical attention. Or, it can be used to forecast the travels of the individuals, to help prevent them from entering a region where the epidemic is known to exist. The invention could also be used by companies that require knowledge of meteorological events to correspondingly dispatch their employees to either address or avoid the meteorological events, depending on the company's goals. The invention could alternately be used by companies whose employees travel throughout the world, to enhance the security of the travelling individuals by helping them avoid severe weather, disease, social disorder or active terrorist cells. Many other applications exist for the present invention, as will be readily apparent to a person skilled in the art.

It will be understood that one advantage of the invention relies on allowing the geographical locations of events and entities to be tracked over time, both retroactively or in the future.

Another advantage of the positioning and tracking method of the invention is that it allows to provide a more precise area of effect associated to an event by allowing points of relevance to be dynamically added or removed, and that the local area of effect of each point of relevance be dynamically adjusted in size, thus creating a virtual three-dimensional space-time bubble that includes an evolving geographical area of effect and a duration that will define an event according to these space-time coordinates. More particularly, the three-dimensional space-time coordinates that define an event include a total area of effect in two dimensions that evolves over time. These space-time coordinates are saved as the event data set. This allows to calculate not whether an entity is located in a specific location (e.g. a city) at a specific time (e.g. when the verification is made), but whether the entity is located within any one of the areas of effect of each location, in the present, past and future.

From this, two or more events and/or entities can be evaluated with respect to one another to determine whether their space-time coordinates intersect, and where and when that intersection lies. The adjustment of the size and position of the total area of effect of the event helps represent an event that spreads or shrinks over time, or that moves.

With a first event defined with its space-time coordinates, it becomes possible to determine whether the event will intersect other events or entities and if so, when and where. A model algorithm can be set up to calculate space-time coordinate data sets for each event and determine where and when the events intersect in space and in time, according to event sizes and positions that vary over time. If a person travelling, then the second event defines linear coordinates over time that represent the person's displacement, herein defined as an entity. A stationary punctual event or a stationary event having a total non-punctual area of effect could also be defined. Or, two or more events having varying sizes and positions over time could be evaluated for intersection of these events.

It is anticipated that the present invention could receive information on events such as evolution of its size or position from user input or automatically, for example directly at its servers or through distant computers by dedicated personnel, from travelers using their mobile phones or other portable electronic devices, by regional, national or international information broadcasters or private information dissemination services, on cloud computing technology, and the like. Consequently, the system information can be updated at regular time intervals to more accurately represent and track a plethora of concurrently occurring events and calculate possible intersections thereof.

1. A computer-implemented method of determining the intersection in space and time between an entity and an event, comprising:
inputting, at an event computer, event data to be stored in an event database, said event data comprising:
event identification data;
finite or infinite event duration data representing an event duration; and
event geographical location data representing geographical locations, said event geographical location data being defined over time during said event duration;
obtaining, at a server, entity data comprising:
entity identification data;
finite or infinite entity duration data representing an entity duration; and
entity geographical location data representing a geographical location, said entity geographical data being defined over time during said entity duration;
obtaining, at said server, said event data;
comparing, at said server, said event geographical location data with said entity geographical location data to determine if they match at corresponding times during said entity and event durations; and
generating, at said server, intersection output data representing matching said event and entity geographical location data at corresponding times during said entity and event durations.

2. The method of claim 1, wherein said step of obtaining, at said server, said entity geographical location data during said entity duration, comprises obtaining said geographical location data at said server from a portable computer device equipped with a Global Positioning System that communicates with said server during said entity duration.

3. The method of claim 1, wherein said step of obtaining, at said server, said entity geographical location data during said entity duration, comprises inputting, at an entity computer, said entity data to be stored in an entity database, with said server retrieving said entity geographical location data from said entity database.

4. The method of claim 1, wherein said geographical locations that represent said event geographical location data comprise a number of discrete geographical points of relevance each having geographical coordinates and a local area of effect about each said point of relevance forming a total area of effect from said local areas of effect.

5. The method of claim 4, wherein said event geographical location data evolves over time by one or more of adding and removing geographical points of relevance and modifying the local areas of effect about each said points of relevance.

6. The method of claim 4, wherein said points of relevance are each defined by longitude and latitude coordinates.

7. The method of claim 4, wherein said points of relevance are geographically movable over time.

8. The method of claim 1, wherein said event duration is retroactive with respect to a current time.

9. The method of claim 1, wherein said entity duration is retroactive with respect to a current time.

10. The method of claim 1, wherein said server includes said event computer.

11. The method of claim 3, wherein said server includes said event computer and said entity computer.

12. The method of claim 1, wherein after the step of generating said intersection output data, the method comprises the additional step of sending, with said server, a warning notification in an electronic message that is representative of said intersection output data to entity coordinates associated to said entity identification data.

13. The method of claim 4, wherein said points of relevance are obtained from a database of geographical locations and each correspond to one of a city, a state and a country.

14. The method of claim 4, wherein the size of each said local area of effects is proportional to the population associated with its corresponding said point of relevance.

15. The method of claim 4, wherein the size of each said local area of effect is defined through customized data entry.

16. A method of representing first and second events in space and time and calculating the intersection thereof comprising:
for each said event, defining a number of discrete geographical points of relevance each having geographical coordinates;
defining a local area of effect about each said point of relevance;
for each said event, generating a total area of effect from said local areas of effect of said event;
defining or adjusting a duration in time for each said event as delimited by start and stop dates and times;
repeating steps (a) to (d) for said duration of each said event until said stop date and time are reached, to integrate the geographical and time parameters to create a space-time data set for each said event; and
calculating the intersection of said first and second events in space and in time from the data sets of said first and second events.
